(19) United States
(12) Patent Application Publication
(10) Pub. No.: US 2011/0271502 A1
(43) Pub. Date: Nov. 10, 2011

(54) PLIERS FOR ESTABLISHING A SLIDING-SLEEVE CONNECTION

(75) Inventors: Ralf Legler, Altersbach (DE); Horst Hofmann, Unterschonau (DE); Georg Holland-Moritz, Rotterode (DE); Thomas Wagner, Bermbach (DE)

(73) Assignees: REHAU AG & CO., Rehau (DE); RENNSTEIG WERKZEUGE GMBH, Viernau (DE)

(21) Appl. No.: 13/143,782

(22) PCT Filed: Jan. 8, 2010
(86) PCT No.: PCT/EP2010/050146

§ 371 Date: Jul. 8, 2011

(30) Foreign Application Priority Data
Jan. 12, 2009 (DE) 10 2009 000 153.0

(51) Int. Cl. B25B 27/10; B25B 7/12

(52) U.S. Cl. 29/237; 81/355

(57) ABSTRACT

The invention relates to a transmission mechanism for a drive system, having at least one tensioning device and acting in two directions. For force transmission, the tractive device runs between a drive roll and an output roll, which are carried by a frame. A spring coupling is connected in the force transmission section between the drive roll and the output roll and has a nonlinear force-distance characteristic curve.

### BACKGROUND OF THE INVENTION

The invention relates to pliers for establishing a sliding-sleeve connection according to the preamble of claim 1.

Pliers or tools of the generic kind are used to connect plastic pipes with fittings. Here, a sliding sleeve is first pushed over the plastic pipe to be connected, and then its end is broadened. The fitting is inserted in the broadened end, and then, as a result of pushing the sliding sleeve on the plastic pipe, it is connected firmly and in a sealing manner to said pipe.

Numerous tools and pliers for sliding the sliding sleeve on a pipe are known from the state of the art. Such tools in each case carry two clamping jaws with a recess which is adapted to the diameter of the sliding sleeve or of the fitting. With one or more strokes, usually by means of the plier handles, the clamping jaws are moved towards each other, and in the process the sliding sleeve is pushed over the broadened pipe end, and in the process the pipe is pressed together with the fitting. Because the force required to slide the sliding sleeve is huge, such manually operated pliers are usually very large to be able to make available a large lever for the force transmission.

DE 196 21 877 A1 discloses manually operated pressing pliers for establishing clamping connections by pressing sliding sleeves on pipe connection fittings, where the yoke heads which can be moved towards each other are arranged on a guide pipe. Due to this construction, the tool head portion can be moved with respect to the articulation of the pliers and the rest of the body of the pliers, which facilitates the use in places that are difficult to access. The drive mechanism of said pliers is implemented in a manner which is known in principle by an eccentric drive with an eccentric drive pin and an advance ratchet attached to said bolt. The movable yoke head carries a peripheral toothing into which the advance ratchet engages during the operation of the handles, and produces the advance of the movable yoke head. Once the pressing is completed, the clamping state achieved with the force transmission gearing is at first maintained, until the pawl becomes inactive due to the action of the spring lever, and reaches in inactive position. For this purpose, before or after the last work or pressing stroke, the spring element must be clamped to put the pawl in a position ready to be loosened. During the last stroke, the clamping tension at the pawl is eliminated, and disengaged, and thus the return path for the movable yoke head has been cleared. However, the drawing out of the pawl can be triggered already before the end of the sliding sleeve position, so that there is no guarantee that the pressing was completely accomplished. If the pressing is continued instead until the last possible work stroke, then the loosening of the pawl can present considerable difficulties because of the continuing tension.

Another system is known, for example, from DE 103 35 519 A1, in which the jaws can be moved towards each other by means of a screw mechanism. The screw mechanism has the disadvantage that it is relatively time consuming to first establish the clamping connection, and then loosen the device again and return it to the starting state. In addition, it is possible here to unintentionally terminate the pressing prematurely, because there is now indication of the completion of a correct pressing.

U.S. Pat. No. 5,758,729 A describes pliers with an integrated electrical motor for reinforcing the driving force on the jaws of the pliers during normal use. The driving of the movable plier jaws occurs via a toggle lever whose tension is applied via a cam plate. The cam plate is here driven by the electric motor.

From EP 0 900 633 B1 a ring pushing slider is known. The toothed rack construction proposed here makes it possible to move the clamping jaws rapidly closer to the connection piece, and it allows a rapid release at the end of the work. For this purpose, a locking bar which can be set in two positions is provided, which allows the uncoupling of the pinion from the toothed rack.

### SUMMARY OF THE INVENTION

The invention is based on the problem of providing pliers for establishing a sliding-sleeve connection, which, after the pressing has occurred, i.e., after a complete pressing stroke has been performed, allows easy removal of the pliers, after the connection has been established. In addition, the pliers are intended to prevent operating errors, i.e., they cannot be opened before the pressing process has occurred.

The problem is solved by pliers having the characteristics of claim 1.

Pliers according to the invention for establishing a sliding-sleeve connection comprise two jaws which can be moved towards each other, of which a first jaw is arranged in a fixed plier part, and a second jaw is arranged on a guide pin which can be moved axially in the fixed plier part. The jaws serve to receive the pipe ends to be connected, i.e. the sliding sleeve, on the one hand, and the fitting, on the other hand. For this purpose, the jaws present in a known manner a u-shaped recess which is adapted to the dimension of the parts to be pressed.

It is preferred that the jaws can be moved parallel to each other. However, it is also conceivable that the jaws are swiveled about a support point located far away.

According to the invention, the guide pin is connected in a driven manner via a crank drive to a ratchet wheel rotatably supported in the fixed plier part. The crank drive acts in such a manner that, in the case of an imagined continued rotation of the ratchet wheel, the guide pin would always be moved linearly back and forth.

The crank drive comprises the ratchet wheel and a pressure lever. The pressure lever is connected in an articulated manner with one of its ends at a wheel-side support place arranged eccentrically on the ratchet wheel, and with its other end at the end of the guide pin, which end faces the second jaw. During the rotation of the ratchet wheel, the guide pin is moved first in the closing direction, i.e., the jaws move towards each other. After a dead center position of the pressure lever has been reached, and the ratchet wheel continues to rotate in the same direction, a return movement of the guide pin in the opening direction occurs.

The design of said drive mechanism can also be simply mirrored.

The advantage of the invention is particularly that, during further operation of the pliers, after completion of the entire stroke, a moving apart/opening of the jaws occurs automatically, so that a simple release of the jaws from the finished connection is possible. It is also advantageous that the pliers do not allow operating errors, because they cannot be opened before the dead center has been passed.

An additional advantage of the use of the crank drive is that, due to the action of the toggle lever under tension, a force for performing the press connection is applied, which increases with continuing closing of the jaws. This means that the gear ratio between the handle movement and the jaw movement changes during the pressing to make available larger forces in the end phase of the pressing.

The ratchet wheel is operated by means of a handle which is connected in an articulated manner on the fixed plier part. An advance ratchet is supported rotatably in the handle, and pushed opposite the fixed plier part by means of a spring in the direction of the ratchet wheel. The advance ratchet has a ratchet tooth which engages in the toothing of the ratchet wheel, and which causes a rotation of the ratchet wheel during the operation of the handle.

The pliers also have a pawl, which is swiveled by a spring force into the ratchet wheel, and which prevents a return rotation of the ratchet wheel when the handle is operated again, as long as the advance ratchet is not engaged.

Another feature of the invention is that a force gear ratio of the crank drive can be designed variably via the geometry of the crank drive. By means of an advantageous force gear ratio it becomes possible to provide pliers that can be operated with one hand.

In a preferred embodiment of the invention, the guide pin is supported and guided on both sides by means of rollers in the fixed plier part.

Moreover, between the ratchet wheel and the guide pin, a resetting spring is arranged, which, when the ratchet wheel is operated without any load, forces a resetting of the guide pin into its starting position (opened position of the jaws).

### DESCRIPTION OF THE DRAWINGS

The invention is explained in greater detail below in reference to the drawing: The figures show:

FIG. 1: a first embodiment of pliers according to the invention for establishing a sliding-sleeve connection, in top view; and

FIG. 2: a second preferred embodiment of the pliers for establishing a sliding-sleeve connection.

### DETAILED DESCRIPTION OF THE EMBODIMENTS OF THE INVENTION

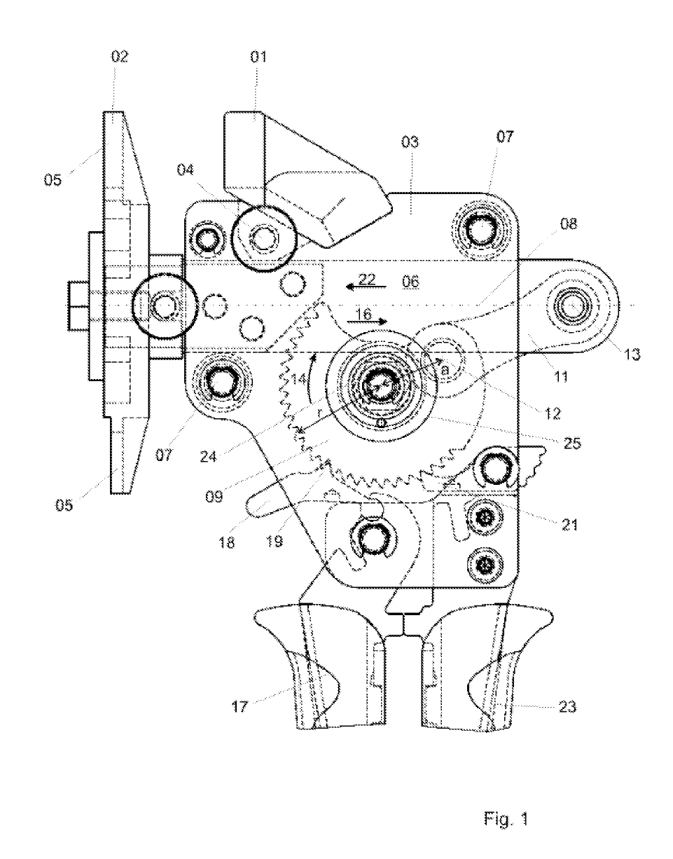

In FIG. 1, a first embodiment of pliers according to the invention for establishing a sliding-sleeve connection is shown. The pliers have, in a known manner, two jaws 01, 02 which can be moved parallel to each other, for receiving pipe parts to be connected. The first jaw 01 is supported in a fixed plier part 03. The first jaw 01 is preferably attached by means of a socket pin 04 in a detachable manner in the fixed plier part 03. As a result, different jaws for receiving different fittings in the fixed plier part can be used.

The second jaw 02 is attached on the first free end of a guide pin 06, opposite to the first jaw 01. The guide pin 06 is supported a manner which allows it to be moved in the fixed plier part 03. The support of the guide pin 06 in the fixed plier part occurs preferably by means of rollers 07, which are provided on both sides of a displacement shaft 08 at a mutual axial separation.

The second jaw 02 can present several nests 05 for different fittings and sliding sleeves. To bring the fitting nest 05 into the work position, the second jaw 02 is preferably arranged in such a manner that it can be swiveled about the displacement shaft 08.

The guide pin 06 is connected via a crank drive to a ratchet wheel 09. The crank drive here comprises the ratchet wheel 09 and a pressure lever 11, which is attached swivelably with one of its ends in a wheel-side support place 12 and with its other end in a pin-side support place 13. The wheel-side support place 12 is here arranged eccentrically on the ratchet wheel 09. The pin-side support place 13 is provided at the end of the guide pin 06, which end is turned away from the jaw 02.

In the case of a rotation—caused by operation of the pliers—of the ratchet wheel 09, in the direction of the rotation arrow 14, a displacement of the guide pin 06 occurs during the pressing stroke via the pressure lever 11, in the closing direction 16, in which the jaws 01, 02 are moved towards each other.

The drive of the ratchet wheel 09 occurs via a handle 17 which is connected in an articulated manner on the fixed plier part 03, where, on said handle, an advance ratchet 18 is arranged swivelably and eccentrically with respect to the swivel point of the handle 17. In the process, a ratchet tooth 19 engages in the toothing of the ratchet wheel 09 and delivers a force in tangential direction. In the case of a closing movement of the handle 17, a rotation of the ratchet wheel 09 in the direction of the rotation arrow 14 always occurs due to the advance ratchet 18.

Moreover, in the fixed plier part 03, a pawl 21 is provided, which engages in the ratchet wheel 09 to prevent a rotation of the ratchet wheel 09 against the rotation direction 14.

The separation between the jaws and the achievable stroke is chosen in such a manner that the pressing is completed at the latest when a dead center position has been reached. If the ratchet wheel 09 continues to be turned, by additional strokes of the handle 17, beyond the dead center position represented in FIG. 1, in which the support places 12, 13, and the center of the ratchet wheel are on a straight line, a movement of the pressure lever 11 past the dead center occurs, and as a result a movement of the guide pin in the opening direction 22 occurs, during which the jaws 01, 02 are moved away from each other. One stroke or a few strokes with the handle 17 are sufficient to release the jaws 01, 02 from the established press connection, and to remove the pliers from the connected pipe.

Now, with simultaneous manual operation of the advance ratchet 18 and the pawl 21, by means of which both ratchets are disengaged from the ratchet wheel 09, the ratchet wheel 09 is operated without any load, and the guide pin 06 is brought into its starting position (widely opened jaws). This occurs automatically when the advance ratchet and the pawl are disengaged, due to a resetting spring 24, which rotates the ratchet wheel 09 into a starting position. For the operation, the advance ratchet 18 and the pawl 21 each possess an operation section, which protrudes beyond the fixed plier part 03. The operation sections are positioned facing each other, in such a manner that they can be operated at the same time with one hand. In a modified embodiment, the resetting spring acts directly on the advance pin 06.

Naturally, on the fixed plier part 03, a second fixed handle 23 for the operation of the pliers is also provided.

The force gear ratio of the crank drive can be selected in such a manner that the pliers can be operated with one hand. Although several strokes are required in that case, the force that needs to be exerted is less. The advantage is that the pliers can be provided with smaller handles, which in turn is advantageous for use in places that are difficult to access. The force gear ratio of the crank drive is determined by the ratio of the radius r of the ratchet wheel 09 to the separation a between the support place 12 and the rotation point of the ratchet wheel 09.

To accelerate the closing of the jaws, the ratchet wheel 09 can be operated directly via a rotary knob 25. Although the use of the rotary knob 25 does not allow the application of large forces, the jaws can be moved in this way into a position in which they are applied essentially without any force on the fitting or sliding sleeve. The rotary knob 25 can also be used for rapid and complete opening of the jaws, as soon as they are not under tension.

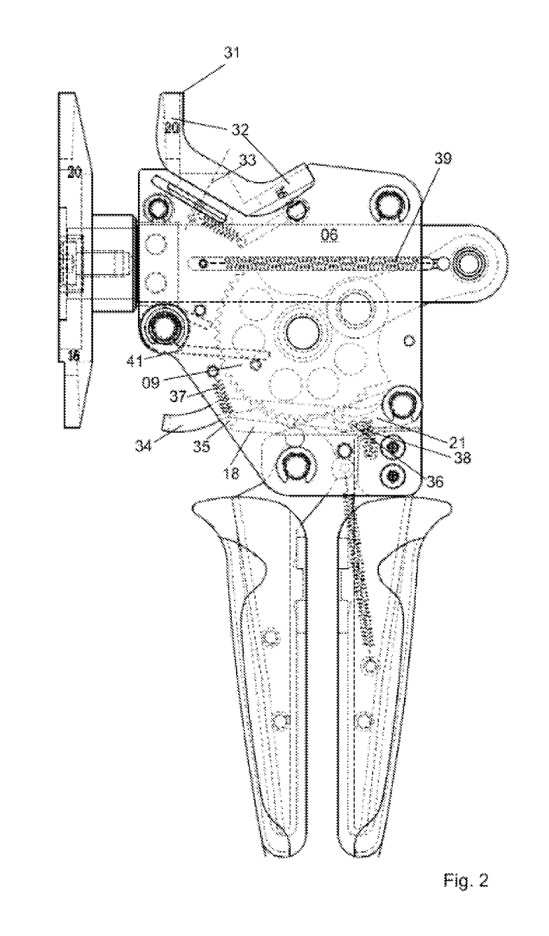

FIG. 2 shows a second preferred embodiment of the pliers according to the invention. These pliers work in accordance with the above-described principle. Some differences in construction are described below. The first jaw 31 is attached rotatably on the fixed plier part 03, in contrast to the embodiment described above. The jaw 31 is designed as a multiple jaw, and it possesses, in this embodiment, two reception areas 32 for receiving different fittings. The reception area to be used can be selected by rotating the jaw 31 by 180° about a rotation axis 33.

In an embodiment which is changed further, the first jaw can be provided, like a revolver, with even more reception areas for the common fitting sizes, so that one can omit the separate entrainment of different jaws. Naturally, this jaw as well can be attached in a detachable manner to be able to cover the entire range of fitting sizes with one or more multiple jaws.

As an additional difference compared to the first described embodiment, a common trigger lever 34 is provided for the advance ratchet 18 and the pawl 21. The trigger lever 34 extends over the entire width of the pliers, and it simultaneously actuates the driving pins 35 and 36, which in each case disengages the advance ratchet 18 and the pawl 21 from the ratchet wheel 09, against the resetting force of the springs 37, 38.

In the embodiment represented in FIG. 2, the resetting of the guide pin 06 occurs by means of a tension spring 39 in cooperation with a torsion spring 41 and the trigger lever 33. When the advance ratchet 18 and the pawl 21 are loosened, the torsion spring 41 moves the ratchet wheel 09 over the dead center of the drive, and then the tension spring 39 pulls the guide pin 06 into the widely open starting position.

1. An apparatus for establishing a sliding-sleeve connection with two jaws which can be moved towards each other for receiving pipe parts to be connected, comprising:
a fixed plier part and a first jaw arranged in the fixed plier part a guide pin and a second jaw arranged on the guide pin such that the second jaw can be moved axially in the fixed plier part;
a crank drive and a ratchet wheel rotatably supported in the fixed plier part, wherein the guide pin is connected in a driven manner via the crank drive to the ratchet wheel, wherein the crank drive includes the ratchet wheel and a pressure lever is having an end connected in an articulated manner in a wheel-side support place, and another end on the guide pin in a pin-side support place, and where, if the ratchet wheel is rotated, the guide pin is first shifted in a closing direction, and, after a dead center position of the pressure lever has been reached, further rotation of the ratchet wheel shifts the guide pin in an opening direction.

2. The apparatus according to claim 1, wherein the pin-side support place is arranged at a free end of the guide pin, which end faces the second jaw.

3. The apparatus according to claim 1, wherein a gear ratio (R) of the crank drive is determined by a radius (r) of the ratchet wheel and a separation (a) between the wheel-side support place of the pressure lever and a center of the ratchet wheel, where R=r/a.

4. The apparatus according to claim 1, further comprising a handle for operating the ratchet wheel, said is handle being connected in an articulated manner on the fixed plier part, said handle having an advance ratchet therein, said handle being supported swivelably, pushed by a spring towards the ratchet wheel, and presents a ratchet tooth which, upon an inward swiveling movement of the handle, engages in the toothing of the ratchet wheel and drives the latter.

5. The apparatus according to claim 4, further comprising a pawl which engages, against a spring force, in the ratchet wheel, and prevents a return rotation of the ratchet wheel upon an outward swiveling movement of the handle.

6. The apparatus according to claim 5, wherein the advance ratchet and the pawl present an operation section which protrudes over the fixed plier part.

7. The apparatus according to claim 6, wherein the advance ratchet and the pawl are positioned with respect to each other in such a manner that their operation sections can be operated simultaneously with one hand.

8. The apparatus according to claim 5, wherein the advance ratchet and the pawl can be operated via a common trigger lever.

9. The apparatus according to claim 1, wherein the guide pin in the fixed plier part is supported and guided on both sides of a displacement shaft by rollers.

10. The apparatus according to claim 1, further comprising a resetting spring arranged, on the ratchet wheel, which forces a resetting of the guide pin into a starting position when the ratchet wheel is operated without any load.

11. The apparatus according to claim 1, wherein the second jaw is supported swivelably on a first free end of the guide pin about the displacement shaft of the latter, and further comprising at least two different recesses provided on the second jaw, which in each case can be swiveled in a position facing the first jaw.

12. The apparatus according to claim 1, wherein the first jaw is attached in a detachable manner on the fixed plier part.

13. The apparatus according to claim 1, further comprising a rotary knob attached on the ratchet wheel, by means of which a manual rotation of the ratchet wheel can be carried out.

14. The apparatus according to claim 1, further comprising a fixed handle provided on the fixed plier part.
